(19) United States
(12) Patent Application Publication
(10) Pub. No.: US 2025/0304455 A1
(43) Pub. Date: Oct. 2, 2025

(54) SOUND-ABSORBING MICROSPHERE, METHOD FOR PREPARING SAME, AND SPEAKER

(71) Applicant: AAC Microtech (Changzhou) Co., Ltd., Changzhou (CN)

(72) Inventors: Jie Zhang, Changzhou (CN); Hezhi Wang, Changzhou (CN); Zhongyang Wang, Changzhou (CN); Chao Wang, Changzhou (CN)

(21) Appl. No.: 18/733,828

(22) Filed: Jun. 4, 2024

Related U.S. Application Data
(63) Continuation of application No. PCT/CN2024/085584, filed on Apr. 2, 2024.

(51) Int. Cl. C01B 37/00; H04R 1/02; H04R 1/28

(52) U.S. Cl. CPC C01B 37/005; H04R 1/025; H04R 1/288; C01P 2004/34; C01P 2004/61

(57) ABSTRACT

The disclosed is a sound-absorbing microsphere, method and a speaker. The sound-absorbing microsphere is composed of molecular sieves and adhesives. The sound-absorbing microsphere includes a spherical body and one or more hollow structures formed by depressions on a surface of the spherical body. A maximum depth or width of the hollow structure is 2% to 50% of a diameter of the spherical body. One or more hollow structures connected to the outside are fabricated on the sound-absorbing microsphere, such that the microsphere has a larger effective surface area capable of absorbing more gas molecules, thereby achieving better sound-absorbing effects. By filling the sound-absorbing microsphere into the speaker, better frequency reduction effects are achieved, and the sound performance is significantly improved. The sound-absorbing microsphere according to the present disclosure has a larger effective surface area, such that the effects of frequency reduction are bettered, and the sound performance is improved.

### CROSS REFERENCE TO RELATED APPLICATIONS

The present application is a continuation of PCT Patent Application No. PCT/CN2024/085584, entitled “SOUND-ABSORBING MICROSPHERE, METHOD FOR PREPARING SAME, AND SPEAKER,” filed Apr. 2, 2024, which is incorporated by reference herein in its entirety.

### TECHNICAL FIELD

The present disclosure relates to the technical field of electroacoustic conversion, and in particular, relates to a sound-absorbing microsphere, a method for preparing same, and a speaker.

### BACKGROUND

With the continuous development of portable electronic devices such as smart phones, Bluetooth headsets, and the like, users are imposing higher and higher requirements on audio quality. To enhance the audio quality and improve sound effects of a speaker, it is common practice is to load acoustic materials in the rear cavity of the speaker to increase the volume of a virtual rear cavity, thereby improving the audio quality.

Upon encapsulation of the speaker, the volume of the cavity affects an overall resonance frequency: the smaller the cavity, the higher resonance frequency. A molecular sieve, as a porous material, is capable of constantly adsorbing and desorbing air inside the cavity, thereby indirectly increasing the volume of the cavity. However, due to the constraints of portable devices like smartphones, to achieve a better low-frequency effect of the speaker, the resonance frequency of the product is required to be as low as possible, and additionally, the speaker is expected as small as possible to save space. Therefore, a cavity filling material with higher frequency reduction performance needs to be developed.

In the related art, the sound-absorbing material filled in the rear cavity of the speaker is generally an ordinary spherical sound-absorbing microsphere, and the frequency reduction function is achieved by placing a plurality of spherical sound-absorbing microspheres in the rear cavity according to actual requirements. However, where an overall structure of the spherical sound-absorbing microsphere is determined, the effective surface area thereof limits the amount of adsorbing gas, and the sound-absorbing material with the same volume is capable of adsorbing more air. As a result, the effective area of the spherical sound-absorbing microsphere in the related art is small, and overall frequency reduction effects are poor.

Therefore, it is desired to provide a new sound-absorbing microsphere to address the above problem.

### SUMMARY

An object of the present disclosure is to provide a sound-absorbing microsphere having a hollow structure, such that a larger effective surface area is acquired, and better frequency reduction effects are achieved.

In a first aspect, some embodiments of the present disclosure provide a sound-absorbing microsphere composed of molecular sieves and adhesives. The sound-absorbing microsphere includes a spherical body and one or more hollow structures formed by depressions on a surface of the spherical body, a maximum depth or width of the hollow structure is 2% to 50% of a diameter of the spherical body.

As an improvement, the hollow structure is spherical or semi-spherical.

As an improvement, the molecular sieve includes one or more of an MFI molecular sieve, an MEL molecular sieve, or an FER molecular sieve; and the molecular sieve is composed of silica and a second metal element, wherein the second metal element includes one or more of aluminum, iron, zinc, or zirconium.

As an improvement, a molar ratio of the silica to the second metal element is greater than or equal to 100.

In a second aspect, some embodiments of the present disclosure provide a method for preparing a sound-absorbing microsphere, applicable to preparation of the sound-absorbing microsphere as described above. The method includes: S1, form deionized water into small droplets by spraying, microfluidization, or electrostatic separation, spray the droplets into a low-temperature liquid at a temperature below 0° C., and rapidly cure the liquid to form ice beads on a surface of the low-temperature liquid. S2, mix molecular sieves, adhesives, and water, and uniformly stir a resulted mixture to obtain a molecular sieve slurry. S3, form the molecular sieve slurry into droplets by spraying, microfluidization, or electrostatic separation, and spray the droplets into the low-temperature liquid with the ice beads floating on the surface thereof, such that the droplets of the molecular sieve slurry are rapidly solidified by colliding with the ice beads to form a microsphere that sinks to the bottom. S4, take out the sunk microsphere and placing the microsphere into a low-pressure vacuum environment, and remove ice from the microsphere by sublimation to obtain the sound-absorbing microsphere.

As an improvement, a density of the low-temperature liquid is greater than 0.92 kg/L.

As an improvement, a diameter each of the ice beads suspended on a surface of the low-temperature liquid is less than 50% of a diameter of each of the droplets.

As an improvement at least 50% of the ice beads have a diameter in the range of 20 μm to 100 μm.

As an improvement, at least 50% of the droplets have a diameter in the range of 200 μm to 500 μm.

As an improvement, in S2, a ratio of the molecular sieve to the adhesive to the water is 1:0.02-0.1:0.5-2.

As an improvement, the hollow structure is spherical or semi-spherical.

As an improvement, the molecular sieve includes one or more of an MFI molecular sieve, an MEL molecular sieve, or an FER molecular sieve; and the molecular sieve is composed of silica and a second metal element, wherein the second metal element includes one or more of aluminum, iron, zinc, or zirconium.

As an improvement, a molar ratio of the silica to the second metal element is greater than or equal to 100.

In a third aspect, some embodiments of the present disclosure provide a speaker. The speaker includes a housing having a receiving space, a sounding unit disposed in the housing, and a rear cavity collaboratively defined by the sounding unit and the housing. The rear cavity is filled with the sound-absorbing microsphere as described above.

As an improvement, the hollow structure is spherical or semi-spherical.

As an improvement, the molecular sieve includes one or more of an MFI molecular sieve, an MEL molecular sieve, or an FER molecular sieve; and the molecular sieve is composed of silica and a second metal element, wherein the second metal element includes one or more of aluminum, iron, zinc, or zirconium.

As an improvement, a molar ratio of the silica to the second metal element is greater than or equal to 100.

Compared to the related art, according to the present disclosure, the sound-absorbing microsphere is composed of a molecular sieve and an adhesive, and the sound-absorbing microsphere includes a spherical body and one or more hollow structures formed by depressions on a surface of the spherical body. A maximum depth or width of the hollow structure is 2% to 50% of a diameter of the spherical body. One or more hollow structures connected to the outside are fabricated on the sound-absorbing microsphere, such that the microsphere has a larger effective surface area capable of absorbing more gas molecules, thereby achieving better sound-absorbing effects. By filling the sound-absorbing microsphere into the speaker, better frequency reduction effects are achieved, and the sound performance is significantly improved.

### BRIEF DESCRIPTION OF THE DRAWINGS

For clearer descriptions of the technical solutions according to the embodiments of the present disclosure, drawings that are to be referred for description of the embodiments are briefly described hereinafter. Apparently, the drawings described hereinafter merely illustrate some embodiments of the present disclosure. Persons of ordinary skill in the art may also derive other drawings based on the drawings described herein without any creative effort.

FIG. 1 is a schematic perspective view of a sound-absorbing microsphere according to some embodiments of the present disclosure;

FIG. 2 is a flowchart of a method for preparing a sound-absorbing microsphere according to some embodiments of the present disclosure; and

FIG. 3 is a schematic structural view of a speaker according to some embodiments of the present disclosure.

Reference numerals and denotations thereof: 100—sound-absorbing microsphere; 101—spherical body; 102—hollow structure; 10—speaker; 1—housing; 2—sounding unit; and 3—rear cavity.

### DETAILED DESCRIPTION

The technical solutions in the embodiments of the present disclosure are described in detail clearly and completely hereinafter with reference to the accompanying drawings for the embodiments of the present disclosure. Apparently, the described embodiments are only a portion of embodiments of the present disclosure, but not all the embodiments of the present disclosure. Based on the embodiments of the present disclosure, all other embodiments derived by persons of ordinary skill in the art without any creative efforts shall fall within the protection scope of the present disclosure.

### Embodiment 1

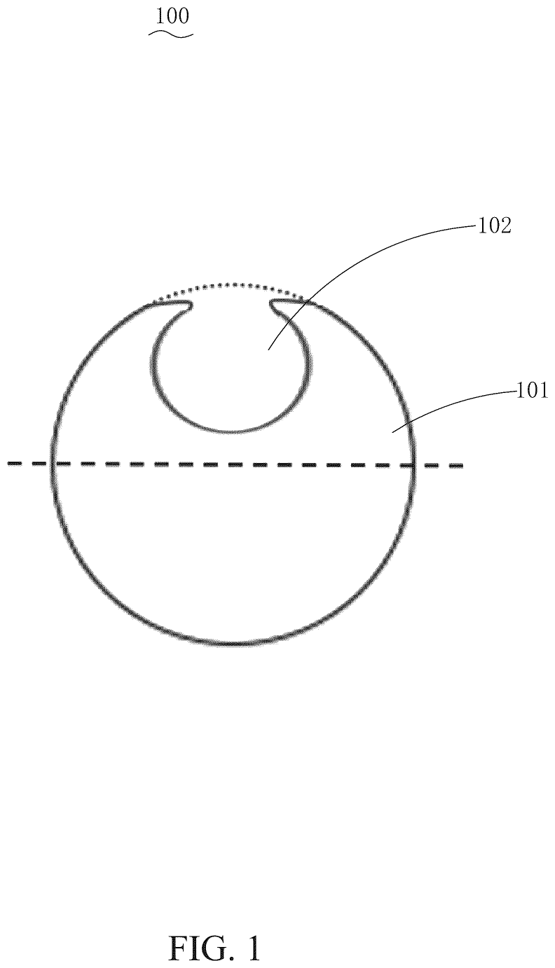

Referring to FIG. 1, an embodiment of the present disclosure provides a sound-absorbing microsphere 100. The sound-absorbing microsphere 100 is composed of molecular sieves and adhesives. The sound-absorbing microsphere 100 includes a spherical body 101 and one or more hollow structures 102 formed by depressions on a surface of the spherical body 101. The maximum depth or maximum width of the hollow structure 102 is 2% to 50% of a diameter of the spherical body 101. One or more hollow structures 102 that are communicated with the outside are fabricated on the sound-absorbing microsphere 100, such that the sound-absorbing microsphere 100 has a larger effective surface area capable of adsorbing more gas molecules, thereby achieving better sound-absorbing effects. By filling the sound-absorbing microsphere 100 into the speaker 10, better frequency reduction effects are achieved, and the acoustic performance is significantly improved.

In this embodiment, the hollow structure 102 is spherical or semi-spherical.

In this embodiment, the molecular sieve includes one or more of an MFI molecular sieve, an MEL molecular sieve, or an FER molecular sieve. In this embodiment, the molecular sieve is composed of silica and a second metal element. In this embodiment, the second metal element includes one or more of aluminum, iron, zinc, or zirconium.

In this embodiment, a molar ratio of the silica to the second metal element is greater than or equal to 100.

### Embodiment 2

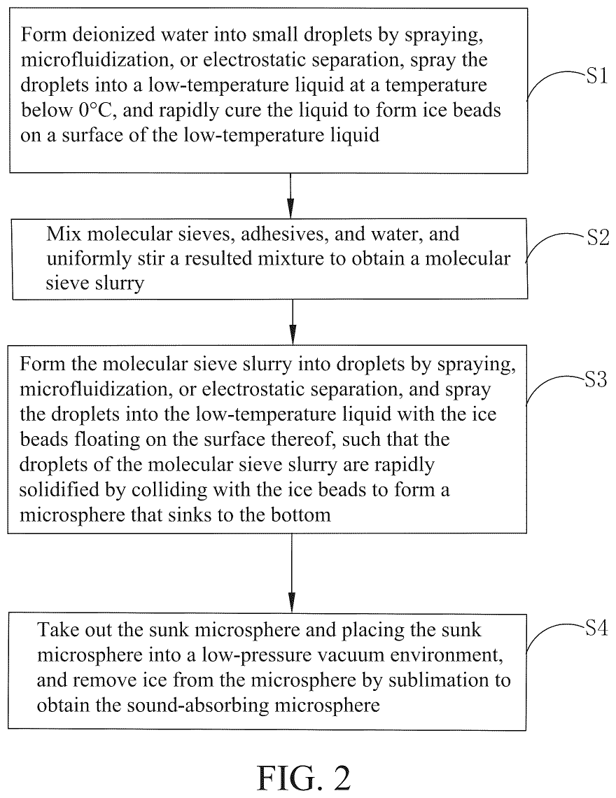

Referring to FIG. 1 and FIG. 2, an embodiment of the present disclosure provides a method for preparing sound-absorbing microspheres, applicable to preparation of the sound-absorbing microsphere 100 as descried above. The method includes as follows.

In S1, deionized water is formed into small droplets by spraying, microfluidization, or electrostatic separation, the droplets are sprayed into a low-temperature liquid at a temperature below 0° C., and the liquid is rapidly cured to form ice beads on a surface of the low-temperature liquid.

In S2, molecular sieves, adhesives, and water are mixed, and a resulted mixture is uniformly stirred to obtain a molecular sieve slurry.

In S3, the molecular sieve slurry is formed into droplets by spraying, microfluidization, or electrostatic separation, and the droplets are sprayed into the low-temperature liquid with the ice beads floating on the surface thereof, such that the droplets of the molecular sieve slurry are rapidly solidified by colliding with the ice beads to form a microsphere that sinks to the bottom. The liquid has a low temperature, such that the water droplets and the molecular sieve slurry droplets are rapidly solidified upon contact with the liquid.

Preferably, when the number of ice beads floating on the surface of the low-temperature liquid is small, S3 is paused and S1 is repeated before proceeding with S3.

Specifically, the method for preparing the ice beads and the molecular sieve slurry droplets include, but is not limited to, spraying, microfluidization, electrostatic separation, and the like.

In S4, the sunk microsphere is taken out and placed into a low-pressure vacuum environment, and ice is removed from the microsphere by sublimation to obtain the sound-absorbing microsphere 100.

Specifically, in the sound-absorbing microsphere 100 obtained by the S1 to S4, one or more hollow structures 102 that are communicated with the outside are fabricated on the sound-absorbing microsphere 100, such that the microsphere has a larger effective surface area capable of adsorbing more gas molecules, thereby achieving better sound-absorbing effects. By filling the microsphere into the speaker 10, better frequency reduction effects are achieved, and the acoustic performance is significantly improved.

In this embodiment, a density of the low-temperature liquid is greater than 0.92 kg/L. The low-temperature liquid has an appropriate density, which is greater than that of ice, such that small ice beads are capable of floating on the surface of the low-temperature liquid, and waiting for combination with the molecular sieve slurry droplets. At the same time, the density of the small ice beads is less than that of the microspheres formed by curing after the molecular sieve slurry droplets collide with the ice beads, such that the molecular sieve slurry droplets quickly sink to the bottom of the liquid after curing. This prevents any influence on subsequent formation of the microspheres.

The density and temperature of the low-temperature liquid may be selected according to actual needs to prepare the sound-absorbing microspheres 100 with different densities.

Optionally, the low-temperature liquid includes liquid oxygen, liquid argon, or the like. The low-temperature liquid is not only liquid oxygen or liquid argon, but may also be any other low-temperature liquid.

In this embodiment, a diameter each of the ice beads suspended on a surface of the low-temperature liquid is less than 50% of a diameter of each of the droplets.

In this embodiment, at least 50% of the ice beads have a diameter in the range of 20 μm to 100 μm.

In this embodiment, at least 50% of the droplets have a diameter in the range of 200 μm to 500 μm.

In this embodiment, in S2, a ratio of the molecular sieve to the adhesive to the water is 1:0.02-0.1:0.5-2.

In this embodiment, to better reflect the performance test of the sound-absorbing microsphere 100 prepared in the present disclosure, the following Embodiment 3, Embodiment 4, Comparative Example I and Comparative Example II are carried out. The measurement results are obtained hereinafter.

### Embodiment 3

An embodiment of the present disclosure provides a method for preparing a sound-absorbing microsphere. The method includes the following operations.
(1) pouring a specific amount of liquid oxygen into an open insulated container, and subjecting deionized water to spray granulation and spraying resulted granules into the insulated container containing liquid oxygen until a layer of ice beads floats on the surface of the liquid oxygen.
(2) weighing 50 g of molecular sieve and add the same to 60 g of deionized water, and then adding 10 g of acrylic adhesive with a solid content of 50% and stirring evenly to obtain a molecular sieve slurry.
(3) subjecting the molecular sieve slurry to spray granulation and spraying resulted granules into the insulated container until most of the ice beads on the surface of the liquid oxygen combine with the slurry droplets and sink into the liquid oxygen, and stopping spray granulation.
(4) placing a resulted molecular sieve microsphere in a low-pressure vacuum environment until all moisture is removed from the microsphere by sublimation, and then placing the microsphere in an oven for drying at 120° C. for 2 hours to obtain a sound-absorbing microsphere 100 with a hollow structure 102.

### Embodiment 4

An embodiment of the present disclosure provides a method for preparing a sound-absorbing microsphere. The method includes the following operations.
(1) pouring a specific amount of liquid argon into an open insulated container, and spraying deionized water to form droplets and spraying the droplets into the insulated container containing liquid argon until a layer of ice beads floats on the surface of the liquid argon;
(2) weighing 50 g of molecular sieve and add the same to 30 g of deionized water, and then adding 10 g of acrylic adhesive with a solid content of 50% and stirring evenly to obtain a molecular sieve slurry;
(3) subjecting the molecular sieve slurry to spray granulation and spraying resulted granules into the insulated container to form droplets until most of the ice beads on the surface of the liquid argon combine with the slurry droplets and sink into the liquid argon, and stopping spray granulation; and
(4) placing a resulted molecular sieve microsphere in a low-pressure vacuum environment until all moisture is removed from the microsphere by sublimation, and then placing the microsphere in an oven for drying at 120° C. for 2 hours to obtain the sound-absorbing microsphere 100 with a hollow structure 102.

### Comparative Example 1

A sound-absorbing microsphere 100 in Comparative Example 1 is prepared by:
(1) weighing 50 g of molecular sieve and add the same to 60 g of deionized water, and then adding 10 g of acrylic adhesive with a solid content of 50% and stirring evenly to obtain a molecular sieve slurry;
(2) subjecting the molecular sieve slurry to spray granulation and spraying resulted granules into an insulated container containing liquid oxygen; and
(3) placing a resulted molecular sieve microsphere in a low-pressure vacuum environment until all moisture is removed from the microsphere by sublimation, and then placing the microsphere in an oven for drying at 120° C. for 2 hours to obtain the sound-absorbing microsphere 100 with a hollow structure 102.

### Comparative Example 2

A sound-absorbing microspheres 100 in Comparative Example 2 is prepared by:
(1) weighing 50 g of molecular sieve and add the same to 60 g of deionized water, and then adding 10 g of acrylic adhesive with a solid content of 50% and stirring evenly to obtain a molecular sieve slurry; and
(2) subjecting the molecular sieve slurry to high-temperature dry spray granulation and then placing a resulted microsphere in an oven for drying at 120° C. for 2 hours to obtain the sound-absorbing microsphere 100.

Acoustic measurements are carried out for the products yielded in Embodiment 3 to Comparative Example 2.

A resonant frequency of the speaker 10 is determined by measuring a frequency-dependent resistor and its phase, and its corresponding zero-crossing point. A speaker 10 having a rear cavity 3 which is 0.5 mL and a sounding unit 2 which is 11 mm*15 mm*3 mm is connected to an impedance analyzer, the microspheres with a diameter of 300 μm to 350 μm are selected to fill the rear cavity 3 of the speaker 10, and an offset value of F₀ is calculated by comparison with a unfilled cavity, that is, ΔF₀.

The results of the acoustic measurements for the examples and comparative examples are as follows:

| | Resonant frequency F₀ | Resonant frequency F₀ | |
|---|---|---|---|
| | of a cavity filled with | of a cavity filled with no | ΔF₀ |
| Sample | microspheres (Hz) | microspheres (Hz) | (Hz) |
| Embodiment | 982 | 741 | 241 |
| III | | | |
| Embodiment | 981 | 732 | 249 |
| IV | | | |
| Comparative | 981 | 768 | 213 |
| Example 1 | | | |
| Comparative | 982 | 785 | 197 |
| Example 2 | | | |

Acoustic test results show that, compared to samples prepared using conventional methods, the sound-absorbing microsphere 100 prepared by the method according to the present disclosure has a higher ΔF₀ value, indicating stronger sound-absorbing performance.

### Embodiment 5

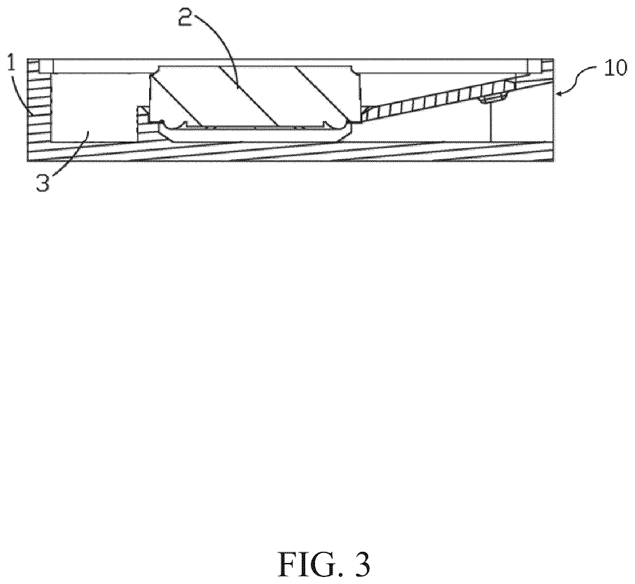

Referring to FIG. 3, an embodiment of the present disclosure provides a speaker 10. The speaker 10 includes a housing 1 having a receiving space, a sounding unit 2 disposed in the housing 1, and a rear cavity 3 collaboratively defined by the sounding unit 2 and the housing 1. The rear cavity 3 is filled with the sound-absorbing microsphere 100 as described above. By filling the rear cavity 3 with the sound-absorbing microsphere 100, the acoustic compliance of the air in the rear cavity 3 is increased, thereby the low-frequency performance of the speaker 10 can be enhanced.

Compared to the related art, according to the present disclosure, the sound-absorbing microsphere is composed of a molecular sieve and an adhesive, and the sound-absorbing microsphere includes a spherical body and one or more hollow structures formed by depressions on a surface of the spherical body. A maximum depth or width of the hollow structure is 2% to 50% of a diameter of the spherical body. One or more hollow structures connected to the outside are fabricated on the sound-absorbing microsphere, such that the microsphere has a larger effective surface area capable of absorbing more gas molecules, thereby achieving better sound-absorbing effects. By filling the sound-absorbing microsphere into the speaker, better frequency reduction effects are achieved, and the sound performance is significantly improved.

Described above are merely exemplary embodiments of the present disclosure. It should be noted that persons of ordinary skill in the art would make various improvements without departing from the inventive concept of the present disclosure, and such improvements shall fall within the protection scope of the present disclosure.

1. A sound-absorbing microsphere, composed of a molecular sieve and an adhesive, wherein the sound-absorbing microsphere comprises a spherical body and one or more hollow structures formed by depressions on a surface of the spherical body, wherein a maximum depth or width of the hollow structure is 2% to 50% of a diameter of the spherical body.

2. The sound-absorbing microsphere according to claim 1, wherein the hollow structure is spherical or semi-spherical.

3. The sound-absorbing microsphere according to claim 1, wherein the molecular sieve comprises one or more of an MFI molecular sieve, an MEL molecular sieve, or an FER molecular sieve; and the molecular sieve is composed of silica and a second metal element, wherein the second metal element comprises one or more of aluminum, iron, zinc, or zirconium.

4. The sound-absorbing microsphere according to claim 3, wherein a molar ratio of the silica to the second metal element is greater than or equal to 100.

5. A method for preparing a sound-absorbing microsphere, applicable to preparation of the sound-absorbing microsphere according to claim 1, wherein the method comprises:
S1, forming deionized water into small droplets by spraying, microfluidization, or electrostatic separation, spraying the droplets into a low-temperature liquid at a temperature below 0° C., and rapidly curing the liquid to form ice beads on a surface of the low-temperature liquid;
S2, mixing a molecular sieve, an adhesive, and water, and uniformly stirring a resulted mixture to obtain a molecular sieve slurry;
S3, forming the molecular sieve slurry into droplets by spraying, microfluidization, or electrostatic separation, and spraying the droplets into the low-temperature liquid with the ice beads floating on the surface thereof, such that the droplets of the molecular sieve slurry are rapidly solidified by colliding with the ice beads to form a microsphere that sinks to the bottom; and
S4, taking out the sunk microsphere and placing the microsphere into a low-pressure vacuum environment, and removing ice from the microsphere by sublimation to obtain the sound-absorbing microsphere.

6. The method according to claim 5, wherein a density of the low-temperature liquid is greater than 0.92 kg/L.

7. The method according to claim 5, wherein a diameter each of the ice beads suspended on a surface of the low-temperature liquid is less than 50% of a diameter of each of the droplets.

8. The method according to claim 7, wherein at least 50% of the ice beads have a diameter in the range of 20 μm to 100 μm.

9. The method according to claim 7, wherein at least 50% of the droplets have a diameter in the range of 200 μm to 500 μm.

10. The method according to claim 5, wherein in S2, a ratio of the molecular sieve to the adhesive to the water is 1:0.02-0.1:0.5-2.

11. The method according to claim 5, wherein the hollow structure is spherical or semi-spherical.

12. The method according to claim 5, wherein the molecular sieve comprises one or more of an MFI molecular sieve, an MEL molecular sieve, or an FER molecular sieve; and the molecular sieve is composed of silica and a second metal element, wherein the second metal element comprises one or more of aluminum, iron, zinc, or zirconium.

13. The method according to claim 5, wherein a molar ratio of the silica to the second metal element is greater than or equal to 100.

14. A speaker, comprising: a housing having a receiving space, a sounding unit disposed in the housing, and a rear cavity collaboratively defined by the sounding unit and the housing;
wherein the rear cavity is filled with the sound-absorbing microsphere according to claim 1.

15. The speaker according to claim 14, wherein the hollow structure is spherical or semi-spherical.

16. The speaker according to claim 14, wherein the molecular sieve comprises one or more of an MFI molecular sieve, an MEL molecular sieve, or an FER molecular sieve; and the molecular sieve is composed of silica and a second metal element, wherein the second metal element comprises one or more of aluminum, iron, zinc, or zirconium.

17. The speaker according to claim 14, wherein a molar ratio of the silica to the second metal element is greater than or equal to 100.
